(19) United States
(12) Patent Application Publication
(10) Pub. No.: US 2004/0133620 A1
(43) Pub. Date: Jul. 8, 2004

(54) Network with prioritized data transmission between sub-networks

(76) Inventor: Joerg Habetha, Aachen (DE)

Correspondence Address: Corporate Patent Counsel, Philips Electronics North America Corporation, P O Box 3001, Briarcliff Manor, NY, 10510, US

(21) Appl. No.: 10/476,803

(22) PCT Filed: May 6, 2002
(86) PCT No.: PCT/IB02/01508

(30) Foreign Application Priority Data
May 7, 2001 (DE) 10122042.1

(51) Int. Cl. G06F 15/16

(52) U.S. Cl. 709/200

(57) ABSTRACT

The invention relates to a network with several sub-networks (1,2,3) which each comprise a controller for controlling the sub-network and which can each be connected via bridge terminals (4,5). To make the data passage through a bridge terminal as efficient as possible, the traffic passed by this terminal is either prioritized by the relevant controllers, or a fixed capacity is reserved for the transmitted data in the relevant sub-networks.

The invention relates to a network with a plurality of sub-networks which can be interconnected by means of respective bridge terminals and which each comprise a controller for controlling a sub-network. Such networks are self-organizing and may consist, for example, of several sub-networks. They are also denoted adhoc networks.

An adhoc network with several terminals is known from the documents “J. Habetha, A.Hettich, J. Peetz, Y. Du: Central Controller Handover Procedure for ETSI-BRAN HIPERLAN/2 Ad Hoc Networks and Clustering with Quality of Service Gurantees, 1^{st} IEEE Annual Workshop on Mobile Ad Hoc Networking & Computing,, Aug. 11, 2000” and “J. Habetha, M. Nadler: Concept of a Centralised Multihop Ad Hoc Network, European Wireless, Dresden, Sep., 2000”. At least one terminal is provided as a controller for controlling the adhoc network. It may be required under certain conditions that a different terminal becomes the controller. The subdivision into sub-networks is necessary once such a network reaches a certain size. Terminals constructed as bridge terminals serve to communicate with the sub-networks. These bridge terminals are synchronized with the sub-networks in alternation. Waiting times arise owing to different MAC frame structures of the connected networks until a bridge terminal can exchange data with the newly synchronized network.

It is an object of the invention to optimize the exchange of data between sub-networks.

According to the invention, this object is achieved by means of a network with a plurality of sub-networks which each comprise a controller for controlling a sub-network and which can be interconnected by means of respective bridge terminals, wherein a higher priority is given to the links between the sub-networks than to the links within a sub-network.

According to the invention, furthermore, this object is achieved by means of a network with a plurality of sub-networks, which each comprise a controller for controlling a sub-network and which can be interconnected by means of respective bridge terminals, wherein a fixed transmission capacity is assigned to the links between the sub-networks.

The two alternative solutions according to the invention are based on the common idea of treating the data transmission between the sub-networks separately or preferentially with respect to data connections within a sub-network. This is advantageous because the bridge terminals, i.e. the data transmission means between sub-networks, constitute a bottleneck as regards the transmission capacity and transmission delay because of the frequency change between the sub-networks.

In the first alternative solution of claim 1, the allocation of transmission capacity for transmitted, so-termed multihop connections is performed dynamically by the controller of the respective sub-networks. Such multihop connections are given a higher priority than purely internal sub-network connections.

In the second alternative solution of claim 4, the arrangement is provided with channels of fixed capacity for multihop connections. This has the advantage that the mechanism of resource requests and resource allocations is bypassed by means of the fixed capacity reservation. This saves time.

Embodiments of the invention will now be explained in more detail below with reference to the Figures, in which:

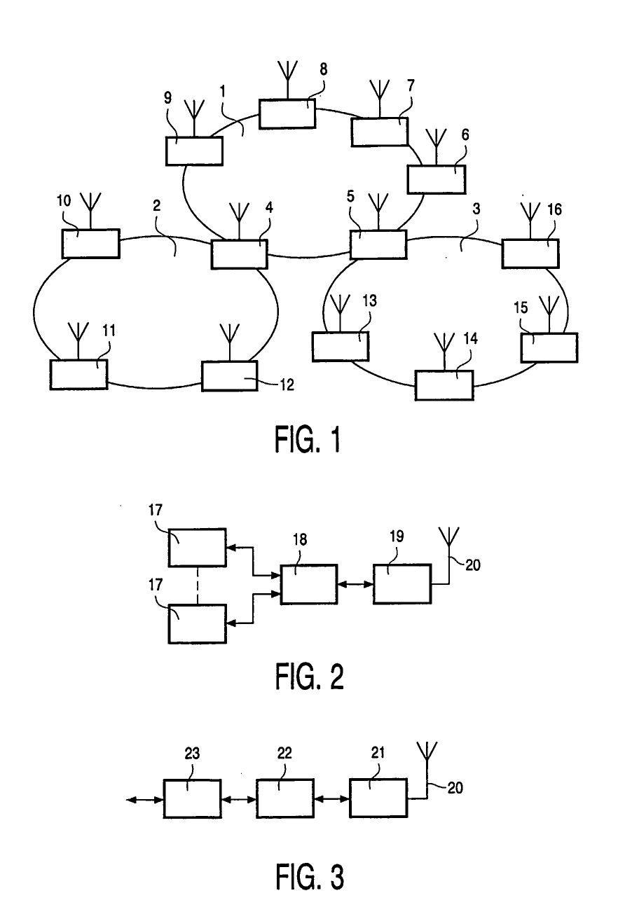

FIG. 1 shows an adhoc network with three sub-networks which each comprise terminals designed for radio transmission,

FIG. 2 shows a terminal of the local network of FIG. 1,

FIG. 3 shows a radio device of the terminal of FIG. 2,

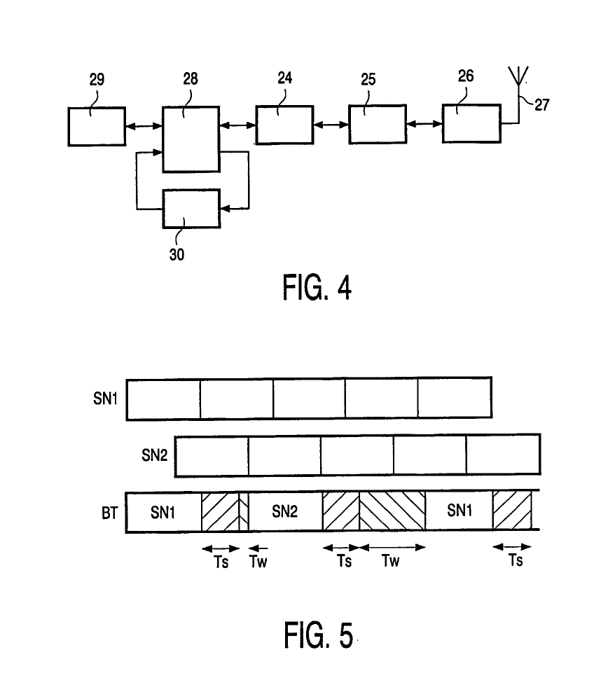

FIG. 4 shows an embodiment of a bridge terminal designed for linking two sub-networks,

FIG. 5 shows MAC frames of two sub-networks and the MAC frame structure of a bridge terminal,

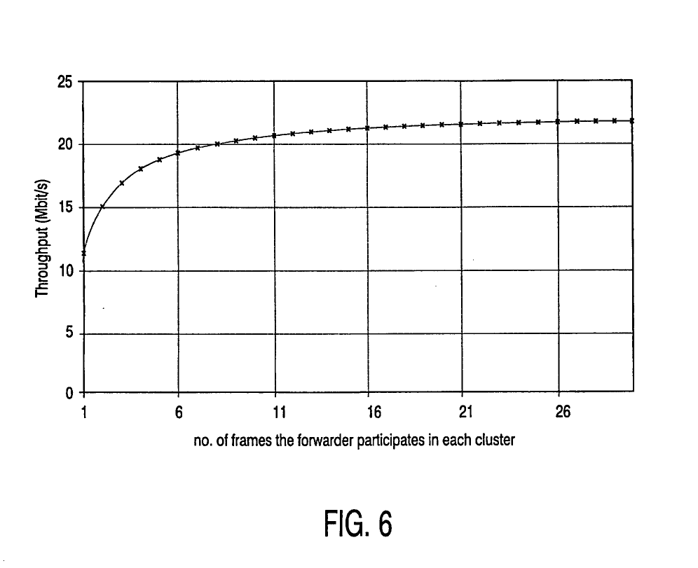

FIG. 6 shows the maximum output of a multihop connection in dependence on the time periods during which the bridge terminal is present in the two sub-networks,

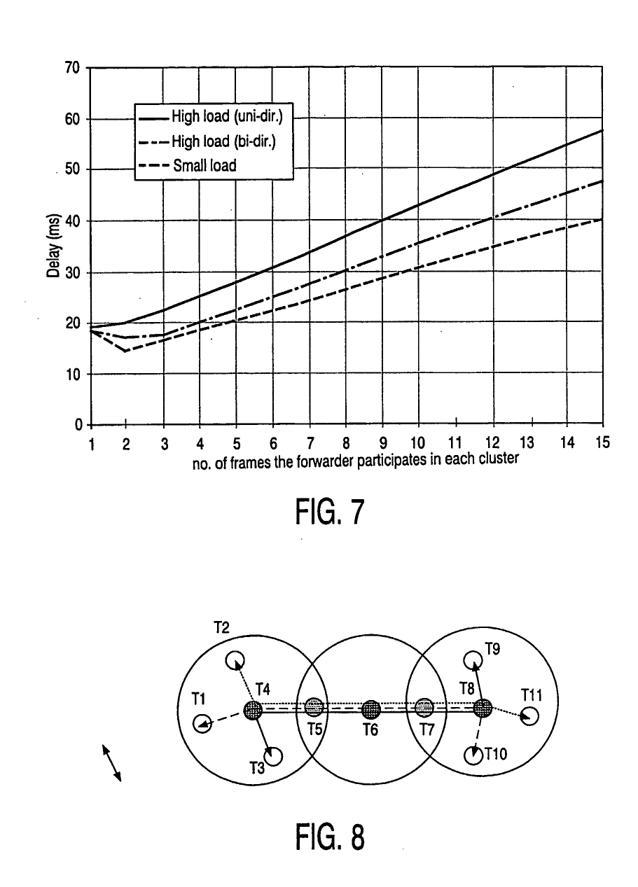

FIG. 7 shows the delay of a multihop connection in dependence on the time periods during which the bridge terminal is present in the two sub-networks, and

FIG. 8 shows a network with three sub-networks and three connections between the sub-networks.

The embodiment described below relates to adhoc networks which are self-organizing, in contrast to traditional networks. Each terminal in such an adhoc network can obtain access to a fixed network and is immediately employable. An adhoc network has the characteristic that the structure and number of participants is not laid down within given limit values. For example, a communication device of a participant may be taken from the network or may be included therein. An adhoc network is not dependent on a fixedly installed infrastructure, unlike traditional mobile telephone networks.

The area of coverage of the adhoc network is usually much larger than the transmission range of one terminal. A communication between two terminals may accordingly render it necessary to activate further terminals so that the latter can pass on messages or data between the two communicating terminals. Such adhoc networks, in which a transfer of messages and data via a terminal is necessary, are denoted multihop adhoc networks. A possible organization of an adhoc network consists in that sub-networks or clusters are regularly formed. A sub-network of the adhoc network may be formed, for example, by terminals interconnected by means of radio links and belonging to participants sitting around a table. Such terminals may be, for example, communication devices for the wireless exchange of documents, pictures, etc.

Two types of adhoc networks may be distinguished. They are decentralized and centralized adhoc networks. In a decentralized adhoc network, the communication between the terminals is decentralized, i.e. each terminal can communicate directly with any other terminal under the condition that the terminals lie within the transmission range of the respective other terminal. The advantage of a decentralized adhoc network is its simplicity and robustness against errors. In a centralized adhoc network, certain functions such as, for example, the function of multiple access of a terminal to the radio transmission medium (Medium Access Control=MAC) is controlled by a certain terminal for each sub-network. This terminal is denoted the central terminal or central controller (CC). These functions need not always be carried out by the same terminal, but they may be transferred from one terminal acting as the central controller to another terminal, which will then act as the central controller. The advantage of a central adhoc network is that an agreement on the quality of service (QoS) is possible therein in a simple manner. An example of a centralized adhoc network is a network organized in accordance with the HIPERLAN/2 Home Environment Extension (HEE) (cf. J. Habetha, A.Hettich, J. Peetz, Y. Du, “Central Controller Handover Procedure for ETSI-BRAN HIPERLAN/2 Ad Hoc Networks and Clustering with Quality of Service Gurantees”, 1^{st} IEEE Annual Workshop on Mobile Ad Hoc Networking & Computing,, Aug. 11, 2000).

FIG. 1 shows an embodiment of an adhoc network with three sub-networks 1 to 3, each comprising several terminals 4 to 16. The terminals 4 to 9 form part of the sub-network 1, the terminals 4 and 10 to 12 of the sub-network 2, and the terminals 5 and 13 to 16 of the sub-network 3. The terminals belonging to a sub-network exchange data through radio links in the respective sub-network. The ellipses drawn in FIG. 1 indicate the radio ranges of the respective sub-networks (1 to 3), in which a substantially unproblematic radio transmission is possible between the terminals belonging to the sub-network.

The terminals 4 and 5 are denoted bridge terminals, because they render possible an exchange of data between two sub-networks 1 and 2 and between 1 and 3, respectively. The bridge terminal 4 is responsible for the data traffic between the sub-networks 1 and 2, and the bridge terminal 5 for the data traffic between the sub-networks 1 and 3.

A terminal 4 to 16 of the local network of FIG. 1 may be a mobile or a fixed communication device and comprises, for example, at least a station 17, a connection control device 18, and a radio device 19 with an antenna 20, as shown in FIG. 2. A station 17 may be, for example, a laptop computer, a telephone, etc.

A radio device 19 of the terminals 6 to 16 comprises not only the antenna 20, but also, as shown in FIG. 3, a high-frequency circuit 21, a modem 22, and a protocol device 23. The protocol device 23 forms packet units from the data flow received from the connection control device 18. A packet unit contains parts of the data flow and additional control information formed by the protocol device 23. The protocol device uses protocols for the LLC layer (LLC=Logical Link Control) and the MAC layer (MAC=Medium Access Control). The MAC layer controls the multiple access of a terminal to the radio transmission medium, and the LLC layer carries out a data flow and error check.

As was noted above, a certain terminal is responsible for the control and management functions and is denoted the central controller in a sub-network 1 to 3 of a centralized adhoc network. The controller in addition acts as a normal terminal in the relevant sub-network. The controller is responsible, for example, for the registration of terminals which come into operation in the sub-network, for the establishment of links between at least two terminals in the radio transmission medium, for the resource management, and for the access control in the radio transmission medium. Thus, for example, one terminal of a sub-network is allocated a transmission capacity for data (packet units) by the controller after registration and after a transmission request has been made.

The data can be exchanged between the terminals in the adhoc network by a TDMA, FDMA, or CDMA method (TDMA=Time Division Multiplex Access, FDMA=Frequency Division Multiplex Access, CDMA=Code Division Multiplex Access). The methods may also be combined. Each sub-network 1 to 3 of the local network is allocated a number of given channels, which are denoted a channel group. A channel is defined by a frequency range, a time range, and, for example in the CDMA method, a spreading code. For example, a certain, always unique frequency range with a carrier frequency f₁ may be available to each sub-network 1 to 3 for data exchange. In such a frequency range, for example, data may be transmitted by the TDMA method. The carrier frequency f₁ may then be allocated to the sub-network 1, the carrier frequency f₂ to the sub-network 2, and the carrier frequency f₃ to the sub-network 3. The bridge terminal 4 operates on the one hand for enabling a data exchange with the other terminals of the sub-network 1 with the carrier frequency f₁, and on the other hand for enabling a data exchange with the other terminals of the sub-network 2 with the carrier frequency f₂. The second bridge terminal 5 present in the local network, which transmits data between the sub-networks 1 and 3, operates with the carrier frequencies f₁ and f₃.

As was noted above, the central controller has the function, for example, of access control. This means that the central controller is responsible for forming frames of the MAC layer (MAC frames). The TDMA method is used here. Such an MAC frame comprises several channels for control information and payload data.

A block diagram of an embodiment of a bridge terminal is shown in FIG. 4. The radio switching device of this bridge terminal comprises a protocol device 24, a modem 25, and a high-frequency circuit 26 with an antenna 27. A radio switching device 28 is connected to the protocol device 24 and is further connected to a connection control device 29 and an intermediate storage device 30. The intermediate storage device 30 in this embodiment comprises a memory element, serves for the intermediate storage of data, and is realized as a FIFO component (First In First Out), i.e. the data are read out from the intermediate storage device 30 in the sequence in which they were written into it. The terminal shown in FIG. 4 is also capable of operating as a normal terminal. Stations connected to the connection control device 29 and not shown in FIG. 4 in that case supply data to the radio switching device 28 via the connection control device 29.

The bridge terminal of FIG. 4 is synchronized alternately with a first and with a second sub-network. Synchronization is understood to mean the entire process of incorporation of a terminal in the sub-network up to the exchange of data. When the bridge terminal is synchronized with the first sub-network, it can exchange data with all terminals and with the controller of this first sub-network. When data are supplied by the connection control device 29 to the radio switching device 28, whose destination is a terminal or the controller of the first sub-network or a terminal or controller of another sub-network which can be reached via the first sub-network, the radio switching device will pass these data on directly to the protocol device 24. The data are put into intermediate storage in the protocol device 24 until the time period determined by the controller for the transmission has been reached. When the data given out by the connection control device 29 are to be sent to a terminal or to the controller of the second sub-network, or to some other sub-network accessible via the second sub-network, the radio transmission is to be delayed up to the time period in which the bridge terminal is synchronized with the second sub-network. The radio switching device accordingly directs those data whose destination lies in the second sub-network or whose destination is accessible via the second sub-network towards the intermediate storage device 30, which stores the data until the bridge terminal is synchronized with the second sub-network.

When data are received by the bridge terminal from a terminal or from the controller of the first sub-network, and the destination thereof is a terminal or the controller of the second sub-network or a terminal or controller of a different sub-network accessible via the second sub-network, these data are also put into storage in the intermediate storage device 30 until the synchronization with the second sub-network is achieved. Data whose destination is a station of the bridge terminal are directly passed through the radio switching device 28 to the connection control device 29, which then passes on the received data to the desired station. Data whose destination is neither a station of the bridge terminal nor a terminal or controller of the second sub-network are sent, for example, to a further bridge terminal.

After the synchronization switch of the bridge terminal from the first to the second sub-network, the data present in the intermediate storage device 30 are read out from the intermediate storage device 30 again in the writing sequence. Then all data whose destination is a terminal or the controller of the second sub-network or some other sub-network accessible via the second sub-network can be passed on immediately to the protocol device 24 by the radio switching device 28 in the time period of synchronization of the bridge terminal with the second sub-network, and only those data whose destination is a terminal or the controller of the first sub-network or some other sub-network accessible via the first sub-network are stored in the intermediate storage device 30.

The MAC frames of two sub-networks SN1 and SN2 are usually not synchronized. Accordingly, a bridge terminal BT is not connected to a sub-network SN1 or SN2, not only during a switch-over time Ts but also during a waiting time Tw. This can be seen in FIG. 5, which shows a sequence of MAC frames of the sub-networks SN1 and SN2 as well as the MAC frame structure of the bridge terminal BT. The switch-over time Ts is that time which is necessary for the bridge terminal to synchronize with a sub-network. The waiting time Tw is the time between the end of the synchronization with the sub-network and the start of a new MAC frame of this sub-network.

Assuming that the bridge terminal BT is connected to a sub-network SN1 or SN2 only for the duration of one MAC frame each time, the bridge terminal BT will only have a channel capacity of ¼ of the available channel capacity of a sub-network. In the other extreme case, in which the bridge terminal BT is connected to a sub-network for a comparatively long period, the channel capacity is half the available channel capacity of a sub-network.

A bridge terminal thus always constitutes a bottleneck as regards the data quantity that can be transmitted and the transmission delay that occurs.

For an optimum utilization of the transmission capacity of a bridge terminal, according to the invention, a series of optimizing measures is taken, as will be explained below.

First of all, the case is discussed in which a bridge terminal utilizes the mechanism in accordance with the HIPERLAN/2 system standard for resource requests (RR) and the subsequent resource allocation or resource grant (RG) by the controller of the respective cluster for data to be passed on. This mechanism involves that a terminal notifies its controller in a so-termed short time slot of its need for long time slots for data transmission. The controller collects the requests from all terminals and subsequently distributes the available capacity of an MAC frame over the individual links of the terminals in accordance with an internal scheduling mechanism. The result of the capacity distribution of a frame is communicated to the terminals in a broadcast period at the start of each MAC frame. The individual information elements of this broadcast phase are denoted resource grants.

Numerous scheduling mechanisms for distributing the capacity over the terminals are known from the literature. A very simple mechanism is, for example, the so-termed “Round Robin” scheduling which is used in two variants. In the so-termed “Non-Exhaustive Round Robin” scheduling, a time slot is allocated first to all terminals or links which have made a request in order of their sequence. If the capacity of the frame has not yet been used up, a further time slot is allocated to all links which requested more than one time slot, etc. In the so-termed “Exhaustive Round Robin” procedure, the individual links are given all time slots they requested in order of their sequence as long as the capacity of the frame is not yet used up. It is common to these two mechanisms as well as to most other known algorithms that they can be combined with a prioritizing of the links. Several priority classes (or priorities for short) are defined, according to which the individual services are graded. The priority of a link is subsequently taken into account in the scheduling. For example, a priority could be taken into account in Round Robin in that first all links with the highest priority are fully served, then all links of the second highest priority, etc. Since the data throughput constitutes a bottleneck in the network discussed, as was noted above, the traffic passed on by the bridge terminal, according to the invention, is given preferential treatment over purely internal sub-network traffic by the controller. This does not mean, however, that a priority assignment specific to the service of individual links is no longer possible. Indeed, each individual link is given a higher priority if it relates to a multihop link. The priorities of the links are laid down in the establishment of the connections.

A further partial aspect of the passing-on of data is formed by the duration of the presence of the bridge terminal in each sub-network. FIG. 6 shows the maximum throughput of a multihop connection for the HIPERLAN/2 system in dependence on the duration of presence in each of the two connected sub-networks (measured in multiples of MAC frames). It is apparent that the throughput increases from one quarter of the maximum payload data rate of 45 Mbits/s, i.e. from approximately 11 Mbits/s, to almost half the maximum throughput, i.e. to approximately 22 Mbits/s, as the participation duration rises. At the same time, however, the average packet delay of the through connections rises, as is shown in FIG. 7. A compromise should accordingly be found between a maximum throughput and a minimum delay.

Advantageously, the duration of presence or participation of the bridge terminal in the relevant sub-networks follows the nature of the connections passed on. If services with high requirements as to the delay are performed, a comparatively short duration of presence (of the order of 2 to 10 frames) is chosen. If the throughput alone is the major concern, as is usual, for example, in the transfer of databases, a longer duration (of the order of 8 to 30 frames) is laid down.

Preferably, the duration of presence or participation in the target sub-network of a through connection should be at least two frames. This is because in this manner of capacity allocation by means of RR and RG the first frame must be used for transmitting the resource request (RR) in the target sub-network and only the second frame can be used for the actual data transmission, after the reception of the RG.

This is also the reason why an asymmetrical duration of presence can be useful in unidirectional links with a high traffic load. Experiments have shown that this is the case especially for very short periods (of up to 3 frames). In such a scenario of a unidirectional link with a high load and a very short period of presence, the bridge terminal advantageously remains one frame longer in the target sub-network than in the source sub-network.

A fixed capacity allocation is used as an additional form of prioritizing of multihop links. The HIPERLAN/2 standard provides two mechanisms for fixed capacity allocation, which are denoted “Fixed Capacity Agreement” (FCA) and “Fixed Slot Allocation” (FSA). In both these methods, the same number of long time slots is reserved for data transmission in each n^{th} frame by the controller for a given connection. The number of these time slots is agreed between the terminal and the controller in the establishment of an FCA or FSA connection. The difference between FSA and FCA is essentially that the reserved time slots are allocated in the same place in each frame in FSA, in contrast to FCA, such that RGs can be fully absent.

A bridge terminal creates an FCA (or FSA) link in each of the two sub-networks when establishing multihop connections each time. The capacity allocation is then agreed between the bridge terminal and the respective controller such that the capacity is reserved periodically in accordance with the period of participation of the bridge terminal in the respective cluster. Alternatively, the FCA or FSA mechanism may be modified or interpreted by the controller such that the fixed capacity agreed per frame is reserved only in the presence of the bridge terminal. The times of presence or participation of the bridge terminal are known to the controller in advance. In this manner no capacity is kept unnecessarily unused during the phase of absence of the bridge terminal. At the same time, the fixed time slot allocation avoids the additional delay which arises in scheduling as a result of the RR and the waiting for the RG. This time gain is of great use especially in the multihop transmissions which are already strongly delayed per se because of the frequency switch. Since minimizing of the delay is only important for services which are critical as to time, a fixed capacity allocation should be used only for services for which time is of critical importance.

Advantageously, all time-critical multihop connections of one priority class which are transmitted over the same partial path are joined together on this partial path into one connection at the level of the security layer. FIG. 8 clarifies this interrelationship in a network comprising several sub-networks and a plurality of terminals. In the Figure, the terminals T1 and T10, the terminals T2 and T11, and the terminals T3 and T9 each have an end-to-end connection which is indicated with a broken, dotted, and continuous line, respectively. It is apparent that all three drawn, active connections take place on the four partial paths between T4 and T5, T5 and T6, T6 and T7, and T7 and T8. If, for example, the end-to-end connection between T1 and T10 and the connection between T2 and T11 belong to the same service or priority class, and the connection between T3 and T9 to a different class, the two connections T1-T10 and T2-T11 will be joined together, according to the invention, into one DLC connection over the four said partial paths at the level of the security layer (Data Link Control, DLC). The result would be on the four partial paths, therefore, no more than two DLC connections of a different service class or priority.

Assuming that the service classes of the two DLC connections are time-critical, then a fixed capacity could be required for both DLC connections on each of the four partial paths mentioned. Joining together of all connections of the same priority class and the requirement of a connection of fixed capacity for the respective priority class are implemented in the network layer. The dimensioning of the required fixed capacity of a DLC connection takes place in the network layer in accordance with the sum of the average data rates of all end-to-end connections which are imaged on this DLC connection, as well as in accordance with the priority of the DLC connection in the case of capacity bottlenecks. The latter means, for example, that, given a full load on the network and an increase in the required capacity of a certain DLC connection, the fixed capacity of this connection can be increased by means of a suitable signaling procedure to the detriment of a connection of lower priority.

Joining together of several end-to-end connections on one DLC connection of fixed capacity achieves a so-termed multiplexing gain, which consists in a more efficient utilization of the fixedly reserved capacity. The joining together of connections which are not critical as to time and which have a lower priority over individual partial paths means a gain which consists in a reduction of the signaling expenditure.

1. A network with a plurality of sub-networks which each comprise a controller for controlling a sub-network and which can be interconnected by means of respective bridge terminals, wherein a higher priority is given to the links between the sub-networks than to the links within a sub-network.

2. A network as claimed in claim 1, characterized in that the links are each allocated a basic priority in dependence on the nature of the data to be transmitted over the respective link, and in that the priority of the link is increased if it is a link between two sub-networks.

3. A network as claimed in claim 1, characterized in that, each time at the start of participation of a bridge terminal in a sub-network, links from this sub-network to some other sub-network of the same or a similar basic priority connected to the bridge terminal are joined together, and in that a fixed, common transmission capacity is allocated to the joined-together links for the duration of participation in the sub-network.

4. A network with a plurality of sub-networks, which each comprise a controller for controlling a sub-network and which can be interconnected by means of respective bridge terminals, wherein a fixed transmission capacity is assigned to the links between the sub-networks.

5. A network as claimed in claim 4, characterized in that the mechanisms of Fixed Capacity Agreement (FCA) or Fixed Slot Allocation (FSA) are provided for the allocation of the fixed transmission capacity.

6. A network as claimed in claim 4, characterized in that a basic priority is assigned to the links in dependence on the nature of the data to be transmitted over the respective link, and links with the same or a similar basic priority are joined together, and a fixed common transmission capacity is allocated to the joined-together links.

7. A network as claimed in claim 1 or 4, characterized in that the network is a network in accordance with the HIPERLAN/2 standard.

8. A network as claimed in claim 1 or 4, characterized in that the bridge terminal chooses its duration of participation in the sub-networks taking part in a connection in dependence on the nature of the data to be transmitted.

9. A network as claimed in claim 1 or 4, characterized in that the bridge terminal always remains in the target sub-network during at least two MAC (Medium Access Control) frames.

10. Method to control a network with a plurality of sub-networks which can be interconnected by means of respective bridge terminals,
wherein a higher priority is given to the lins between the sub-networks than to the links within a sub-network or
wherein a fixed transmission capacity is assigend to the links between the sub-networks.

11. Controller to control a sub-network which can be interconnected by means of respective bridge terminals with at least another sub-network, wherein by the controller
a higher priority is given to the links between the sub-networks than to the links within a sub-network or
a fixed transmission capacity is assigned to the links between the sub-networks.
